(19) United States
(12) Patent Application Publication
(10) Pub. No.: US 2001/0051902 A1
(43) Pub. Date: Dec. 13, 2001

(54) Method for performing secure internet transactions

(76) Inventor: Marc A. Messner, Edmond, OK (US)

Correspondence Address: Edward L. White, P.C., 4th Floor, 50 Penn Place, Oklahoma City, OK, 73118-1803, US

(21) Appl. No.: 09/876,867

(22) Filed: Jun. 8, 2001

Related U.S. Application Data
(63) Continuation-in-part of application No. 09/567,159, filed on May 9, 2000.
Application No. 09/567,159 is a continuation-in-part of application No. 09/490,040, filed on Jan. 24, 2000.
Application No. 09/490,040 is a continuation-in-part of application No. 09/340,603, filed on Jun. 28, 1999.
Application No. 09/340,603 is a continuation-in-part of application No. 09/366,015, filed on Aug. 2, 1999.

(51) Int. Cl. G06F 17/60

(52) U.S. Cl. 705/26

(57) ABSTRACT

A split transaction purchasing method for increasing the security of on-line transactions comprising the steps of—a customer accessing a merchant server and selecting desired goods and services and placing an order for same, the order resulting in the transmission of an order packet to the merchant server and an authorization packet to a bank server; upon receipt of the order packet, the merchant server generating a merchant packet and transmitting same so that it is received by the bank server; the bank server coordinating the merchant packet with the authorization packet; upon successful coordination, the transaction being subjected to normal back-end processing. Also disclosed is an interactive customer approval method for performing secure Internet transactions of the type where a customer transmits an order packet to a merchant indicating a desire to engage in a transaction, and the merchant consequently transmits a merchant packet related to the requested transaction, the method comprising: in an interactive mode, obtaining authorization from the customer for the requested transaction, resulting in an authorization packet; coordinating the authorization packet with the merchant packet; and transmitting an approval packet if coordination is successful.

### CROSS REFERENCES TO RELATED APPLICATIONS

This application is a continuation-in-part of U.S. Pat. App. No. 09/567,159, filed on May. 6, 2000 for a Method for Performing Secure Internet Transactions. That application was, in turn, a continuation-in-part of U.S. Pat. App. No. 09/490,040, for a Method for Marketing and Redeeming Prepaid and Credit Accounts and for use in Online Purchases, filed Jan. 24, 2000. That application was a further continuation-in-part of a prior application for an Apparatus and Method for Marketing and Redeeming Prepaid Accounts for use in Online Purchases, U.S. Pat. App. No. 09/365,766 filed Aug. 3, 1999. That application was finally a continuation-in-part of Apparatus and Method for Performing Secure Network Transactions, U.S. Pat. App. No. 09/340,603 filed Jun. 28, 1999 (“Parent Application”). Pursuant to an election/restriction on or about Aug. 2, 1999, the applicant elected claims 1, 3, and 5 in the Parent Application; the non-elected claims 2 and 4 are included with the present application. Another continuation-in-part application of the Parent Application titled Apparatus and Method of Marketing and Redeeming Gift Certificates for use in Online Purchases, U.S. Pat. App. No.09/366,015 was filed Aug. 2, 1999.

### BACKGROUND OF THE INVENTION

1. Field of the Invention

The invention relates to methods for performing computer network-based transactions. More particularly, the invention relates to a method which increases the security of Internet transactions using accounts similar to existing VISA®, MasterCard®, American Express® accounts and the like. Still, more particularly, the invention relates to a security method which allows an increase in security for on-line purchase transactions while requiring minimal, if any, modification by merchants of their web site designs.

2. Description of the Prior Art

The concept of electronic commercial transactions is relatively new. Ignoring transactions pursuant to telephone calls involving a real person on each end, the concept of electronic transactions between two electronic devices was practically unknown until banks pioneered electronic transactions for wire transfers.

With the rise of the Internet in the early 1980s, long distance electronic transactions became possible for the general public. However, electronic commerce transactions were still relatively rare outside of the above-noted banking transactions until the early 1990s. This was partly because the technologies required for such transactions were not well developed. Also, until the early 1990s there were still a relatively small number of consumers with access to the Internet.

The term “Internet” will be used throughout this document. As used herein, “Internet” means a network of digital logic machines (various types of computing devices) controlled by multiple users, the machines having the capability, using a common or compatible communication protocol or protocols, of communicating pursuant to programming commands or information input by users. One specific embodiment of the term Internet is the computer network currently operating to allow users to communicate with remote servers using the transmission control protocol/Internet protocol (“TCP/IP”). The terms “computer network,” “long distance network,” “electronic network” and other variations of these phrases may be used interchangeably in this document, and are intended to be coextensive with the term “Internet,” but should generally be understood to be limited to systems using TCP/IP.

As used herein, the term “bank” generally means the administrator of the system disclosed in this patent application. The bank may be an existing credit card system operator such as Visa® or MasterCard®. The bank is responsible for operation of the various centralized computer hardware, software and databases needed to implement the present invention. The bank may be referred to by that name or as the administrator or operator of the system. The “bank” need not, in fact, and probably will not be a traditional bank chartered under applicable federal or state banking law; rather, it may simply be a commercial institution which tracks customer accounts and protects the safety of their monetary value.

There have come to be a standardized set of features which attend online purchase transactions. Most merchants offer a “shopping cart” model for use in purchasing goods and services online. When a customer is viewing a merchant's web site using a “browser,” (e.g., Microsoft® Internet Explorer® or Netscape's® Navigator) they can select particular goods or services to add to their “shopping cart.” When they are finished shopping, they so indicate, and they are taken to a “check out” screen. At the check out screen the customer is then prompted to enter information necessary to complete the transaction, such as their payment method, their address, their name, and such other information as the merchant may require. Due to the multiple steps involved in a shopping cart model, many consumers abandon the transactions before they are completed. This abandonment of shopping carts has become a major problem for online retailers and results in the loss of millions of dollars of sales.

To address the abandonment of shopping carts, several merchants have developed reduced-step purchasing models. The best known of these was developed by Amazon.com, and involved a single action to complete a purchase. Amazon obtained U.S. Pat. No. 5,960,411 to Hartman et al., for a Method and System for Placing a Purchase Order Via a Communications Network. Hartman et al., disclosed what Amazon has come to call their “1-click”™ purchase model. In this model, once a customer is “1-click” enabled, they simply click on an icon representing the purchase of an item, and the transaction is complete. There is no need to enter any information to verify the user's name, credit card number, address, or the like at the time of the purchase. Such information is maintained on a customer database at Amazon's server.

In the last several years, there has been an exponential increase in the number of people with access to the Internet. Consequently, Internet business has proliferated. Great quantities of capital have poured into businesses related to the Internet. However, the full potential of the Internet for commercial transactions has not been realized. This is in large part due to concerns among consumers about the security of transactions over the Internet. A 1999 study by Ernst & Young addressed the reasons why consumers had not purchased goods, services or information on the Internet: 97% stated that they were uncomfortable sending credit card data across the Internet. “Internet Shopping Study: The Digital Channel Continues to Gather Steam,” page 11, Ernst & Young, LLP (1999) (study sponsored by the National Retail Federation).

Before engaging in a broader discussion, it may be necessary to discuss how Internet purchase/sales transactions are typically conducted. A customer system is connected via a computer network to a merchant server. The customer selects various goods and services displayed via his browser from the merchant server through the computer network. Once the customer has selected the desired goods and services, he either “checks out” with his shopping cart or presses a 1-click button or the like. The shopping cart checkout procedure results in the transmission of information about the customer's purchase, as well as the selected method of payment to the merchant.

Information regarding the purchase is then transmitted from the merchant server to a processor and/or a credit card network. From this point on, the processing of the order will be referred to herein as “standard back-end processing” or simply “back-end processing.” Back-end processing involves evaluation of the customer's account status by the institution which issued the account in question (“issuing bank”) either by the institution itself or by an out-sourced processor for approving or denying transaction requests by merchants. The processor/credit card network may be able to authorize or approve the transaction with or without communication with the issuing bank. The issuing bank is not to be confused with the “bank,” as that term is generally used in the patent application. If the processor/credit card network is unable to process the transaction, it may be transmitted to the issuing bank for approval. Once the issuing bank and/or the processor have approved the transaction, such approval is communicated back through the computer network or a separate bank network to the merchant, who then typically sends a confirmation page to the customer system, which is displayed on the customer's browser.

Consumers' concerns regarding security are justified to some extent. There are at least three types of theft which can occur with Internet transactions: First, communications containing confidential information can be intercepted by parties other than the intended recipient; Second, what appears to be a legitimate business, may actually be a front for con men; and Third (and possibly most important) customer data stored on a merchant server can be stolen by hackers. These hackers can then use that confidential information to commit fraud or theft (for example, making charges on credit card information intercepted on the Internet). Also, when a user/customer purchases goods or services over the Internet, there is little, if any, way for the customer to know that the merchant/supplier is legitimate. A web site which appears to be a legitimate business may, in fact, be a front established by con artists who plan to use the credit card and other information they obtain to defraud unsuspecting consumers. Finally, hackers can gain unauthorized access to merchant web servers. Once access to the server is obtained, the hacker may steal the information stored on the merchant server, for example, customer names, credit card numbers, and the like. Several hacker attacks on merchant servers have yielded credit card numbers. Clearly these merchant servers are vulnerable.

In order to minimize security concerns related to transmission of data, there are currently two primary competing technologies vying for dominance to provide “secure” Internet transactions: (1) Secure Sockets Layer (“SSL”) protocol and (2) Secure Electronic Transactions (“SET”). Though good at securing data as it is being transmitted, these systems do not secure data resident on a merchant server, such as in the Amazon 1-click system. Both of these technologies assume that transactions on the Internet will use existing means of payment, most commonly credit card accounts (such as Visa®, Mastercard®, American Express®, and the like). SSL and SET are basically mathematical tools designed to encrypt the data related to these existing means of payment, to minimize the risk that this data may be intercepted and misused by an unintended recipient. Both SSL and SET also incorporate communication paths intended to ensure the integrity of transmissions. SET goes further than SSL in verifying the authenticity of entities using the system. Each user in SET is assigned unique identifier(s) and are given keys tied to their identifier(s). For purposes of this document, technology such as SSL and SET may be referred to as “encryption methods,” which is also intended to include other methods of encrypting data.

The Nextcard® has attempted to address the issues of security and customer confidence in a different way. The Nextcard is a “VISA card for Internet users.” The Nextcard attempts to safeguard a user/consumer's credit information by storing the information in a secure environment. In addition, SSL is used for all transactions involving the Nextcard. The basic premise, however, of Nextcard is that “when you use your Nextcard VISA to make purchases over the Internet, you are never liable for fraud.” Nextcard guarantees customers that they will not incur losses due to fraud over the Internet. There are no restrictions regarding the sites from which a Nextcard customer can make purchases. Similarly, if the Nextcard account information is stolen by a merchant or hacker, the customer is not liable. If the real card is stolen by someone who then attempts to use the card on the Internet, a customer is still protected. A customer using a Nextcard online, should have no worries about security or the like. He is financially protected by the “safe shopping pledge.” However, the Nextcard does not protect a user from identity theft where the hackers obtain other personal information about the account-holder (address, phone number, name, etc.) from a merchant. Further, the time and inconvenience suffered by a customer whose information is stolen are not covered by the Nextcard's safe shopping pledge. Also, the Nextcard does not protect merchants from losses related to fraud. Should a stolen number be given to a merchant for a purchase and approved initially, the money credited to the merchant on account of that fraudulent purchase must generally be returned to the issuing bank by the merchant once the fraud is discovered. Thus, the Nextcard does nothing to protect merchants from fraud. A merchant who, without any fault, accepts a fraudulent transaction is generally required to bear the loss associated with the fraud.

Debit cards are commonly used and are often referred to as “ATM cards,” referring to the automated teller or transfer machines in which they can be used to retrieve cash. Debit cards often look like credit cards, but they function in reverse. Instead of borrowing money for each purchase, then paying off the account at a later time as with a credit card, debit cards deduct money from an account for each purchase or withdrawal. Since many debit cards are issued using the Visa®, MasterCard® or similar systems, these debit cards may be used for on-line transactions, but, where this is possible, the debit cards suffer from the same security drawbacks as credit cards. However, the risk to the debit card holder is greater because their liability from theft losses may not be capped; that is, a debit card holder may be responsible for the entire loss if a thief steals money from his account.

A part of the problem with the use of Visa® and MasterCard® accounts online is that once the credit card number and expiration date, as well as the name of the card holder, are obtained, this information can be used in a variety of formats, either on the Internet, via the telephone, or for certain in-person transactions to make an authorized purchase by the person wrongfully obtaining the information. As long as a credit balance remains on the account, a person who wrongfully obtains these numbers can continue making purchases. Theft of the name, account number, and expiration date from a merchant site, or otherwise, is all that is required to utilize these numbers for unauthorized purchases.

The various online-only payment systems have attempted to address security issues by adding layers of security to their payments systems or restricting the type of purchases and the merchants at which they can be used to purchase goods and services. However, though this is a security feature, it is a serious drawback for many of the online only systems which have debuted to date because they can only be used for a limited range of merchants, and online merchants must customize their sites to utilize these payment systems. The customer is limited in his choices, and the merchant must make extensive changes to his merchant web site to accommodate the payment systems. Once these changes have been made to a web site by a merchant, there is no guarantee of the level of traffic the merchant will see from these online-only payment systems.

As noted above, this patent application is a continuation-in-part of a series of patent applications related to computer transaction methods. The model of the predecessor applications included the use of a hardware key, namely an “article” removably inserted into the electronic apparatus. In the prior applications, if the article was inserted in a customer's system, specified electronic transactions were enabled, but if not, they were prevented from being performed. Also disclosed was a split transaction model. In one embodiment of the split transaction model, at or near the same time, a merchant packet was transmitted to a merchant, and a bank packet was transmitted to a bank's purchase server. The merchant then added specific information regarding the purchase and transmitted a merchant packet to the bank. The merchant packet was matched with the corresponding bank packet, and the purchase was approved if all of the components matched appropriately. Subsequent continuation-in-parts expanded on this model. Methods were disclosed for marketing and using prepaid Internet accounts, as well as gifts certificates or coupons for online redemption. In the application for Method for Marketing and Redeeming Prepaid and Credit Accounts for Use in Online Purchases, an outline of a method using existing Visa®, MasterCard®, or similar accounts was disclosed. The basic method consisted of taking the account number and changing or transposing certain portions thereof to create a new number, which was only useful for online transactions processed by the bank.

Many Internet-only payment systems have required merchants to customize their web site to process the Internet-only payment systems. Customization of hundreds of thousands of merchant web sites would be costly and time consuming. Therefore, each of these systems have only garnered a small slice of the merchant market. Granted, some of the systems have garnered approval from some of the larger online merchants such as Barnes&Noble, E-Bay and the like, but even these behemoths do not control the bulk of the transactions performed online. A large portion of the transactions which take place online are sold by the e-equivalent of “mom and pop” stores. Further, much, if not most, on-line commerce is related to goods and services not generally offered by the main-stream on-line merchants—good and services such as sexually explicit material and digital music of questionable copyright validity.

To date, few of the companies considered mainstream players in online commerce have engaged to any extent in the sale of sexually explicit material. In fact, Yahoo® recently announced that it would curtail sales of sexually explicit material.² The lack of major players presents an opportunity for unscrupulous sex merchants. Some merchants selling sexually explicit material obtain what a customer believes is a one-time authorization for a transaction then charge the customer's account multiple times for a “subscription” or other recurring “services.” With a traditional credit card, there is no way to preclude these multiple charges, and there is no clear record of just what sort of charges were authorized. ² “Users: Yahoo! Extends Porn Fight,” AP, May 1, 2001, Brian Bergstein.

Another large area of Internet commerce is the sale and/or “trading” of music online. Again, since no official protocol has been reached regarding the protection of copyrighted information via sale on the Internet, the mainstream merchants have not yet begun to engage in the sale of music, video, and other entertainment media directly via the Internet in a large way.³ ³ The major players do sell CDs and the like for subsequent shipment to purchasers, but they generally have not sold music for direct download via the Internet in MP3 format or the like.

The lack of dominant market players in many large types of Internet commerce, which have built up a strong level of customer trust, emphasizes the need for an Internet payment system with increased security with respect to the less well-known Internet merchants. These merchants are set up to process standard credit card account numbers using the VISA® and/or MasterCard® systems, and in some cases, also using American Express® and several other major credit cards. One potential weakness in many of the existing and proposed Internet-only payment system is their dependence on modification of merchant web sites to allow processing of transactions using these systems. Modification of even a small percentage of existing merchant web sites to accommodate a new payment method would be difficult to achieve, given the fact that there are tens of thousands (if not hundreds of thousands) of merchant sites. However, given the relatively large percentage of on-line transactions which are repudiated by customers, costing merchants millions, if not billions, of dollars, there may be a large enough economic motivation to cause merchants to customize their sites if it will reduce the number of repudiated transactions. In order to be more universal, a system with improved security would preferably work with merchant web sites with minimal, if any, modification to their existing configuration to process VISA® or MasterCard® accounts.

Another major problem not addressed by the prior art is customer repudiation of on-line purchases. Many merchants experience a high percentage of subsequent customer contests of on-line transactions. That is, the customer may assert that the transaction was fraudulent in some way and refuse to pay. Since there is no “signature” on a receipt as with brick and mortar purchases, the merchant may lack solid evidence that the customer authorized the transaction. There is a great need for customer authentication to “replace the paper receipt that customers sign at the point of sale in the physical world.”⁴ The desire to avoid charge backs which, for some online merchants, exceed 10% or even 20%, may be sufficient to motivate them to make changes in their web site to implement such a system. ⁴ Kevin Weller, Senior VP of technology at e-Visa, a division of Visa USA, quoted in “Visa, third parties add technology to protect shoppers,” American Bankers.com, Nov. 15, 2000.

### SUMMARY OF THE INVENTION

In view of the foregoing disadvantages inherent in prior art, it is an object of the invention to provide a method for performing secure Internet transactions. More particularly, it is an object of the present invention to provide a system for dramatically increased security of on-line transactions while requiring minimal, if any, modification by merchants of existing merchant web sites. It is also an object of the present invention to increase customer control over on-line purchase transactions while giving merchants better evidence that transactions were, in fact, authorized by the customer. These objects are accomplished, as will be more fully disclosed below, primarily by two features: first, by interactive client approval, requiring customer input after a merchant submits a merchant packet requesting approval of a proposed transaction; and/or second, splitting a customer's information into two parts, and sending less sensitive information to the merchant directly and more sensitive information to the bank, then coordinating these two parts at the bank. The interactive client approval process is intended to serve as a sort an on-line proxy for the signing of a paper receipt in brick and mortar transactions. Splitting the transaction into two parts, the split transaction model, prevents the merchant (and by extension hackers) from having access to sufficient information to undertake fraudulent transactions.

It is an object of the invention to provide a system which is available for use in purchases exclusively on the Internet. A key component of this system is the centralized processing of transactions and record-keeping. A centralized server or set of servers processes transactions using the present invention.

It is an object of the present invention to accomplish the foregoing objects also using an interactive approval process. The interactive approval process may incorporate a method for allowing the bank to identify the Internet address of a particular customer at any given time; at the time a customer signs on to the Internet, his computer may relay to the information regarding the customer's existing web address to the bank. The bank may store the customer's IP address temporarily in a server. Then, when a merchant packet requesting payment is received by the bank, the bank sends a packet to the customer, at the IP address from its server, requesting additional information needed to authorize the transaction. The additional information may be either mined automatically from a database existing on or communicating with the customer's computer, or, the information may be provided directly by the customer entering the data himself. Once the requested information is provided by the customer manually or mined from a database, the bank compares the information with known account information of the customer, and if the information checks out, the transaction is sent for standard back-end processing.

Alternatively, customer approval may be obtained after a merchant requests a transaction by generating a request for approval packet and transmitting it to the customer based on an Internet address mined from the merchant's request for authorization packet. Since the merchant and the customer are, by definition, in communication in order to specify the terms of the requested transaction, the merchant will have the customer's IP address. This address can be transmitted with the merchant packet and used by the bank to initiate the interactive customer approval process.

The interactive approval process may be transparent to the merchant. That is, in one embodiment, the merchant does not have to know about the actual approval process, nor customize its site for the interactive approval process. All the merchant knows is that in due time, it will receive back either an acceptance or rejection of the proposed transaction. Alternatively, where the merchant's web site is customized, to a greater or lesser extent, to facilitate the present invention, the merchant may be a more active participant in the approval process. For example, the bank may merely reply to the merchant—in response to a request for authorization—that the customer participates in the present system, and the merchant might generate the request packet for transmission to the customer.

It is also an object of the present invention to provide a payment system which may be set to only allow one-time charges by a merchant. Many merchants offer services which will repeatedly charge a user's credit card account over a period of time. For example, a publisher of an online magazine may, from time to time, charge a recurring fee for a subscription to the magazine. The present invention allows a user to select a setting which prevents the authorization of recurring charges. When this setting is engaged, only one-time charges may be authorized. Thus, when a user in the interactive mode views the merchant's charges, the customer can be confident that there are no other charges which will appear on his credit card subsequent to the authorization of the initial charge.

It is a further object of the present invention to incorporate features of electronic “wallets” which lessen the burden on a user executing an Internet transaction. In essence, using the present invention and a “wallet,” the only data required to be entered by a user to execute a transaction would be a pin number and the description of goods or services to be purchased.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

### BRIEF DESCRIPTION OF THE DRAWINGS

The invention will be better understood and the objects other than those set forth above will become apparent when consideration is given to the following detailed description thereof. Such description makes reference to the annexed drawings wherein:

FIG. 1 is a schematic representation of the relationship among the client system, the merchant server, processor, and the bank server used in implementing the present invention.

FIG. 2 is a flow chart illustrating the operation of the split transaction model with interactive customer approval.

FIG. 3 shows the contents of the order packet.

FIG. 4 shows the contents of the merchant packet.

FIG. 5a shows the minimum contents of the request for approval packet.

FIG. 5b shows the contents of the request for approval packet, including optional identifying information.

FIG. 6a shows the minimum contents of an authorization packet.

FIG. 6b shows the contents of the authorization packet, including optional identifying information.

FIG. 7a shows the minimum contents of an approval packet.

FIG. 7b shows the contents of an approval packet, including optional identifying information.

FIG. 8 shows the contents of a confirmation packet, including optional identifying information.

FIG. 9 is a flow chart illustrating the operation of the split transaction model.

FIG. 10 is a flow chart illustrating the operation of the interactive client approval model.

### DETAILED DESCRIPTION OF PREFERRED EMBODIMENTS

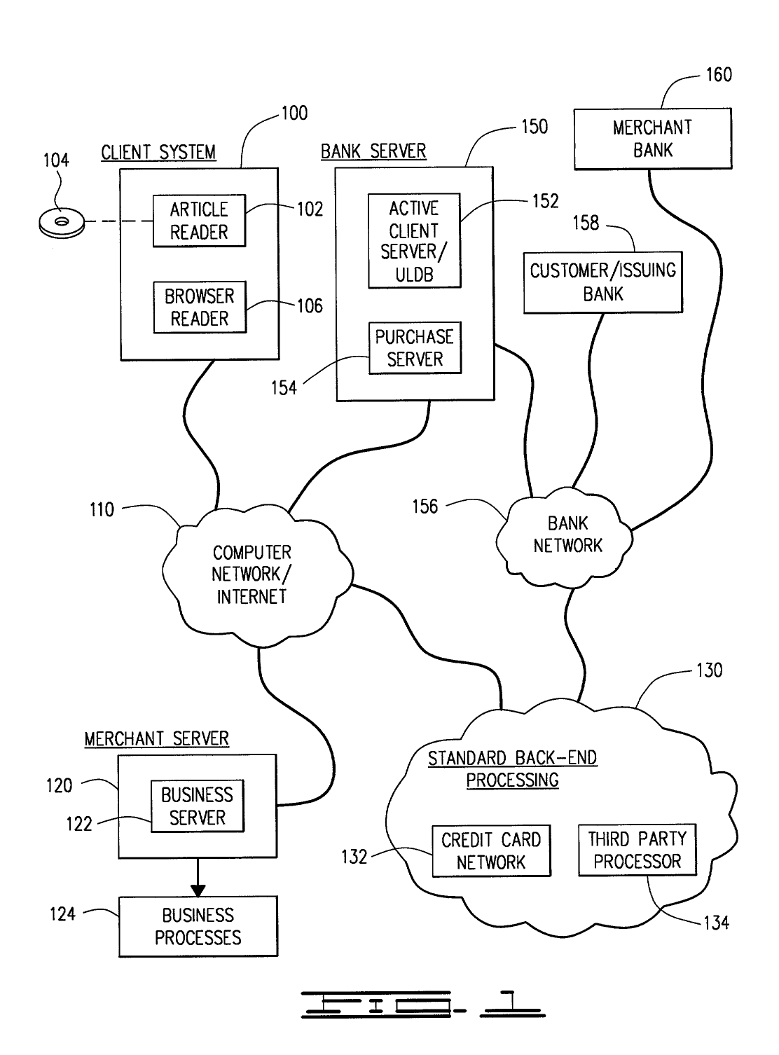

FIG. 1 generally illustrates the components used by one embodiment of the present invention. Referring now to the drawings, where like numerals represent like parts, the present invention incorporates an electronic apparatus 100 such as a personal computer. The electronic apparatus may also be referred to as a client or customer system. It should also be understood that, rather than using the personal computer, a net device such as a “web TV” system could also be used, though improvements and additional features may need to be made to web TV systems presently available before they could accommodate the present invention. In the future, additional devices (such as personal digital assistants, game play stations, and the like) will be developed specifically to access the Internet and to perform transactions thereon. The electronic/client system 100 apparatus can represent all of these devices, and similar devices performing a like function.

Cooperating with the electronic apparatus is a display screen. The display screen allows the electronic apparatus to display various messages. Also cooperating with the electronic apparatus are one or more data input devices. The data input devices could be a keyboard, a mouse, a microphone for inputting the user's voice and/or voice commands, biometric input devices, and the like. Additional input devices are possible, and they are intended to be incorporated within the spirit of this invention.

Also incorporated within the electronic apparatus may be an article or media reader 102. The media reader will be adapted to read an “article” 104. It is anticipated that the article/media will be, at least initially, a compact disc (“CD”). The article/media 104 could also be any number of other devices, such as a web card. The web card has the look of a typical credit card, but also can be read by a regular CD reader. A floppy disk with security features could also be used. Also, a smart card, which is a credit card with an electronic memory incorporated therein, could also be used. A paper entitled “Smart Card Technology: Introduction to Smart Cards” by David B. Everett, and published by Smart Card News, Ltd. gives an overview of the technology employed in smart cards, and the article is incorporated herein by reference. Smart cards are not widely available in the United States at this time, but they are very popular in Europe. The reader 102 will be an appropriate mechanism for the technology used in the article 104. Alternatively, the article could look like a traditional credit card with a magnetic stripe containing coded account information.

The electronic apparatus 100 may also have incorporated or installed thereon a client-specific software code. If client-specific code is installed, there will, by necessity, need to be either memory or hard drive-type devices to store the client-specific software code, if it is incorporated thereon. If the software is installed on the electronic apparatus, the need for the article 104 may be eliminated. However, this may reduce the security of the system.

The electronic apparatus 100 will also incorporate display software, probably a browser 106, for displaying information transmitted to the electronic apparatus via the computer network 110. The two most commonly used browser software packages are Microsoft's® Internet Explorer® and Netscape's Navigator®. Alternatively, any browser which facilitates data transfer using the TCP/IP protocol may also be used.

The electronic apparatus 100 may also preferably incorporate an electronic wallet. Electronic wallets are relatively new “devices.” The electronic wallet is a software element which precludes the need for the user to specifically input his personal data such as a mailing address and the like, when purchasing goods or services over the Internet. The electronic wallet may also incorporate features to track expenditures on the Internet.

The electronic apparatus will also incorporate a communication means for communication with the computer network 110. The communication means may be a typical dial-up modem, a cable modem, or the like. The communication means access to a transmission means for linking with a computer network. The transmission means may be a standard telephone line, an ISDN line, a cable line or the like. It is also anticipated that the communication means may incorporate a “wireless” technology; wireless may include transmissions from an earth-bound transceiver or from a satellite.

Once a communication link is established via the communication means with a computer network 110, a further link can be established with a supplier/merchant server 120. Goods and/or services are offered for sale on the supplier/merchant server. The supplier/merchant server may also be in communication with the merchant business server 120; this communication typically will occur through a merchant firewall. Customers cannot contact the merchant's business server directly, because it is protected by the merchant firewall. The merchant's business server 122 further controls or directs business processes 124. Business processes include inventory control, shipping, and the like.

A third party processor 134 or credit card network 132 may also be incorporated in the purchase approval loop. The processor 134 processes transactions for a merchant server 120. The processor will typically have a client server which communicates with the Internet, and a processing server which processes transactions submitted to the processor. For many of the larger financial institutions, the financial processing is done by a company called First Data and other similar companies, which approve credit card transactions as a proxy for financial institution; otherwise, the transaction may be sent to standard back-end processing 130 through the issuing financial institution 158 which issued the customer account (also called the “issuing bank” or “customer bank”).

The electronic apparatus 100 also communicates via the computer network with a bank server 150. The bank server may also be in communication with multiple devices such as a purchase server 154 or a billing server, which may be further in communication via a firewall with the bank account information server. The bank account information server is the bank's main computer where records and information on customers are kept. The bank account information server may be in further communication through a bank network with a merchant bank 160 or the customer bank 158. The bank server 150 may also incorporate an active client server 152. The active client server may maintain a database of accounts using the present invention. Further, the active client server may monitor the Internet address of customer using the system; and, if the active client server performs this type of function, it may be referred to as a user location database or “ULDB.”

There are several optional features which may be desirable. First, customer-specific software may be installed onto the electronic apparatus 100, eliminating the need for an article 104. This would allow the account to be used whether the article is present or not. Installing the software onto the electronic apparatus lessens the security of the system (and a customer could be so informed), but it may be desirable for convenience. A second option is portability. Portability allows a customer to use the account on any electronic apparatus with both an article reader and a communication means allowing access to the computer network. The customer may be able to select the portability option when he sets up his account. Where portability is activated, all of the software code necessary to operate the present invention on the client system may reside on the article.

The bank server 150 is in communication with the computer network 110. It preferably incorporates an active client server 152 and a purchase server 154. The bank server 150 may be in further communication via a bank network 156 with a customer/issuing bank 158 and/or a merchant bank 160. If there is communication via the bank network 156 with the above-noted institutions, automatic clearing house (“ACH”) transactions may be accomplished to transfer amounts to and from the customer/issuing bank 158 and/or the merchant bank 160.

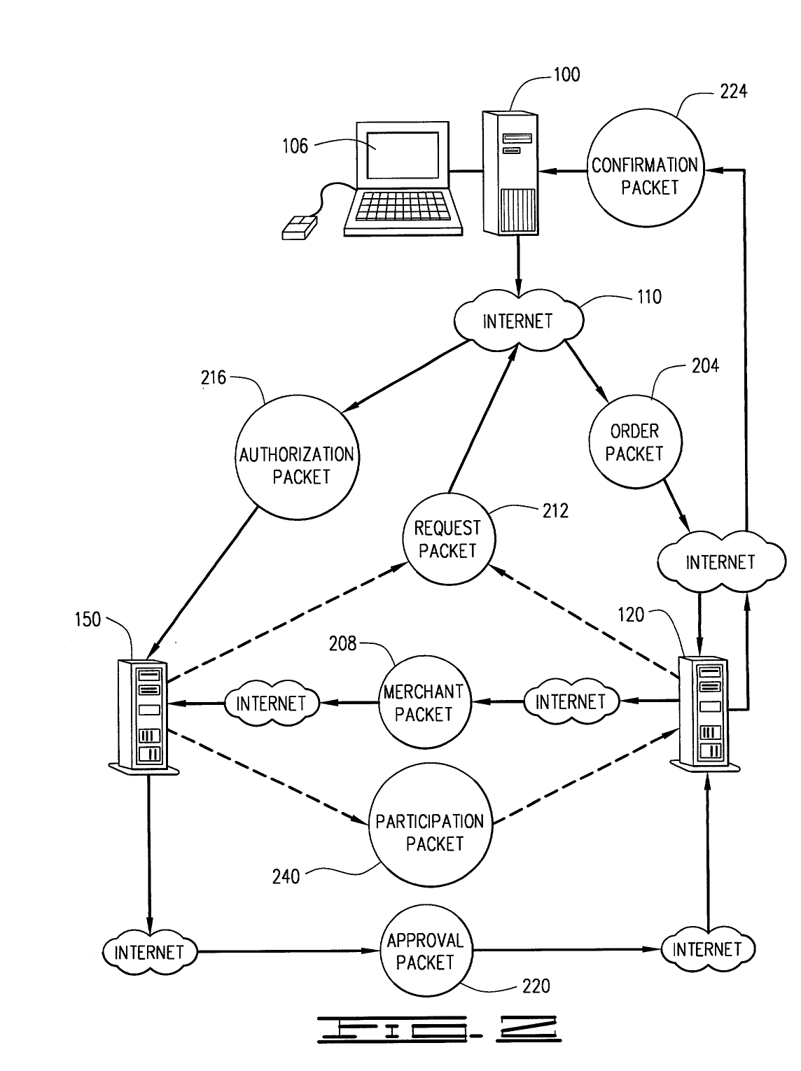

FIG. 2 illustrates one embodiment of the present invention. The client server 100 is in communication with a merchant server 150 through the Internet 110. While browsing, using his browser 106, the client selects the goods or services he desires to purchase. Once the client/customer has finally selected all of the goods and services he wishes to purchases, he also selects a method of payment. At that point, the order is submitted, resulting in the generation and transmission of an order packet 204 through the Internet to the merchant server 120. The merchant server, based on the information in the order packet 204, generates a merchant packet 208, which is transmitted via the Internet to the bank server 150. At this point, one of two things may happen. First, if an authorization packet 216 was transmitted by the client server 100 at or about the same time the order packet 204 was transmitted, the bank server 150 may coordinate an authorization packet 216 with the merchant packet 208. Second, if the client system 100 did not transmit an authorization packet at or about the same time as the order packet was transmitted, the bank server may submit a request packet 212 through the Internet to the client system. It is to be understood that when it is said that the bank server 150 transmits the request packet 212 through the Internet 110 to the client system 100, the bank server 150 may delegate or give this responsibility to a third party server. There are many issuing banks, third party processors, and other institutions involved with the approval of credit card payments on or through the Internet. Therefore, it may be advantageous to have a centralized server which filters merchant packets 208, and generates a request packet 212 for all accounts that are participating in the system described in the present invention. Another embodiment, which may be desirable, is to have the bank server 150 simply reply to a merchant, in response to a merchant packet, that the customer is enabled with the present invention; the reply in such a case will be referred to as a participation packet 240. The merchant server 120 then generates a request packet 212 and transmits it to the client system 100. For simplicity's sake, however, it will be assumed that the merchant packet 208 is transmitted directly to the bank server 150, which itself, generates a request packet 212 if needed.

The request packet 212 is received by the client system 100. In response, either automatically or by entry of data by the client himself, an authorization packet 216 is transmitted back to the bank server 150. The bank purchase server 154 coordinates the authorization packet 216 with the merchant packet 208. If a successful coordination of the two packets is achieved, back end processing may then be performed to determine whether there is, for example, sufficient credit on client's account to authorize the purchase in questions and the like.

If back end processing approves the transaction, an approval packet 220 is sent via the Internet to the merchant server 120. Upon receipt of the approval packet 220, the merchant server 120 may preferably generate a confirmation packet 224, which is transmitted via the Internet to the client system 100.

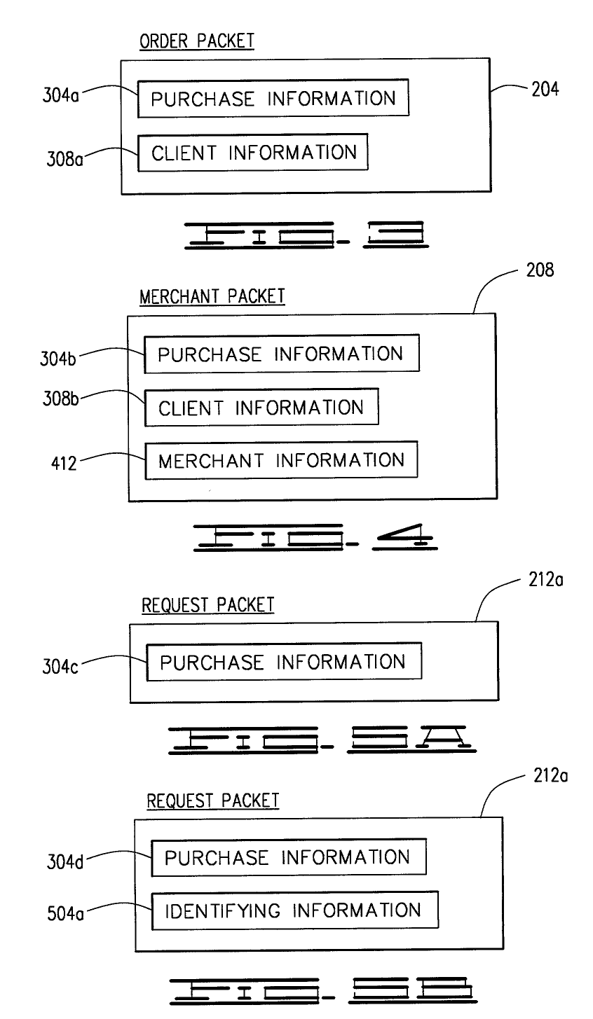

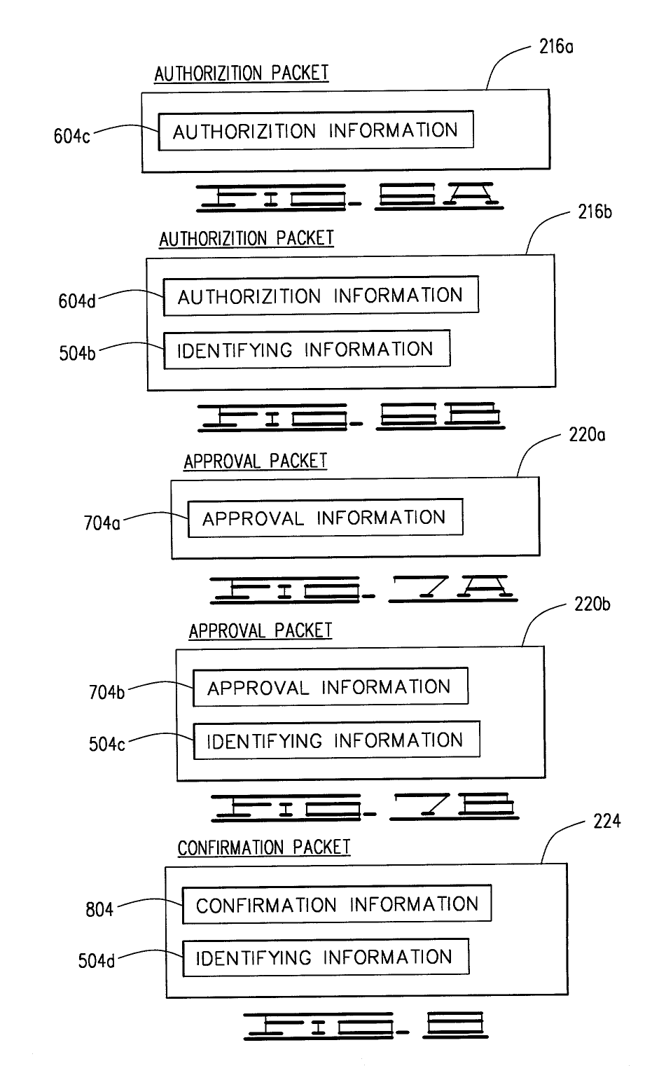

FIGS. 3 through 8 illustrate the various information packets transmitted among and between the client system 100, the merchant server 120, and the bank server 150. FIG. 3 shows the order packet 204; FIG. 4 shows the merchant packet 208; FIGS. 5a and 5b both show a request packet 212; FIGS. 6a and 6b both show the authorization packet 216; FIGS. 7a and 7b both show the approval packet 220; and FIG. 8 shows the confirmation packet 224. Information which could be included in the various packets is practically limitless. The information which could be included ranges from the name and address of the client to the credit or other account which is to be used to pay any charges incurred, passwords related to the account, the issuing bank, a description of the goods and service and/or services identified and chosen by the client, the date/time the packet was generated and/or sent, the Internet address from and/or to which the packet was sent, and similar pieces of information could all be included.

The order packet 204 is generated by the client system 100 and transmitted through the Internet 110 to the merchant server 120. At a minimum, the order packet includes purchase information 304a and client information 308a. The purchase information 304a could include a description of the goods and/or services to be purchased, the price of the selected goods and services, information on how the client was directed to or arrived at the merchant server 120 to view and select the goods and services, and similar information. The purchase information 304a is the information the merchant needs to identify the exact goods and services the customer wishes to purchase and to identify how much the customer is to be charged for said goods and services. At the e very least, the purchase information 304a must include the purchase price of the goods and/or services selected. The client information 308a may include the client's name, the client's mailing and/or billing address, the account which the customer uses to pay for the goods and services, and such other information as the merchant may require to process the order packet 204. The client information 308a may also include a transaction-specific expiration date (“TSED”). Many financial accounts incorporate an expiration date as a part of the information provided to authorize a transaction; a TSED is an expiration date which is only applicable for the single transaction being authorized; it cannot be used for a different transaction subsequently. If a TSED is not sent with the order packet 204, it may be subsequently added to one of the other packets, such as the merchant packet 208, the request packet 212, or the authorization packet 216.

At least some confidential information may be incorporated within the order packet 204. The shipping information and the account information may be classified as confidential information. The shipping information would include at least the persons name, mailing address, city, state and zip code. Many people would consider this information confidential, and would not want it sold or otherwise published or made available on the Internet. Certainly the client's real credit or debit account number or other payment account identifier would be considered confidential information. However, the confidential information sent with the order packet 204 would be, in and of itself, insufficient to allow anyone obtaining such information to authorize a fraudulent transaction.

The merchant packet 208 is generated by the merchant server 120 and transmitted via the Internet to the bank server 150. The merchant packet includes purchase information 304b, client information 308b, and merchant information 412. The purchase information 304b, at a very minimum, advises the bank server 150 that a transaction has been requested by a customer, which is implicit in the fact that the merchant packet 208 has been sent. The same purchase information 304a included in the order packet 204 may be incorporated within the merchant packet 208. Alternatively, the merchant may “strip” (i.e., selectively remove) some of the information from the purchase information 304a originally included with the order packet 204. The merchant may also add additional information to the purchase information 304b included with the merchant packet. The client information 308b included with the merchant packet 208 may be the same as the client information 308a included with the order packet 204, or it may be stripped to some extent. Except to the extent that the merchant server 120 maintains a data base of information on the client in question, the merchant will not be able to add information to the client information 308a transmitted in the order packet. However, not all of the information in the client information packet 308a may be required for the merchant packet 208, and some information may be stripped by the merchant in creating client information 308b. The merchant information 412 is at least an identifier which allows the bank server 150 to confirm that the merchant server 120 is participating in the appropriate payment system.

Information indicating that a client's account uses the present invention must be present in an active client server 152 maintained within the bank server 150 before any purchases can be approved. Again, note that the bank may delegate the maintenance of the active client server to a third party. That is, the payment method/account specified in the order packet 204 must be enabled to use the present invention.

In addition, where the client must interactively approve the requested transaction, the client's Internet address must also be known before transactions can be interactively authorized. There are many ways that a client's Internet address can be obtained, including, but not limited to the following: (a) a customer sending of an initial user online packet to the bank server 150 when he signs on the internet and a sign off packet at or near the time the user signs off the Internet; (b) a sign on packet could be sent to the bank server 150 at or near the same time as a client transmits an order packet 204; (c) the client's Internet address could come from the order packet and would either be stored by the merchant server 120 or transmitted to the bank server 150 with the merchant packet 208. Three of the myriad of ways that the customer's Internet address can be identified are described in more detail below. The preferred embodiment is discussed last.

First, when a client establishes an Internet connection, the bank server 150, may be notified of the client's Internet address, and other user identification and information and/or user code by the sending of a packet, which may be referred to as a “sign-on” packet, containing at least a customer identifier (such as an account number) and the customer's then existing Internet address. The sign-on packet will preferably contain some of the same information which is contained in an authorization packet 216. This data is placed in the active client server 152, also referred to as a uniform locator database (“ULDB”). The ULDB associates account information with the user's Internet address for recall as needed. While the user remains online, “keep alive” packets may be sent to the bank server 150 indicating the user is still online at the specified IP address. When the user disconnects from the Internet 110, the bank server 150 stops receiving the “keep alive” packets indicating the user is disconnected. The user's IP address is then removed from the ULDB 152. When the user establishes a new connection, the process repeats itself. Alternatively, the ULDB 152 may retain a client until a sign off packet is sent.

Second, at or near the same time when the user transmits an order packet 204 requesting a purchase, a sign-on/authorization packet 216 could be sent to the ULDB 152 specifying the user's IP address and related information. The information submitted at or near the same time the merchant packet 220 was submitted could be maintained on the active client server 152 for a limited period of time, during which, if the merchant packet 220 were not submitted to the bank for approval and coordinating with the authorization packet 216 would be deleted from the ULDB 152. If a successful coordination occurred, the interactive client approval process could take place. Where the interactive client approval step is removed from this method, it is in essence, the split transaction model. The split transaction model, with or without subsequent interactive client approval, could work without modification of merchant web sites. The client system 100 could send all of the information traditional on-line orders incorporated, including payment account number and expiration date to the merchant. This sort of information is usually sufficient to authorize on-line transactions in and of itself; but, with accounts operating using the present invention, the bank server 150 would not send an approval packet unless a successful coordination of the merchant packet 208 with an authorization packet 216 were made. Further, this method could also involve a query back from the bank server 150 to the client system 100 if a successful coordination were accomplished. This “double check” interactive client approval step (the initial sending of the authorization packet comprising the first client approval) would basically involve the sending and receiving of a request packet 212 and a second authorization packet 216. This double check step would make it even clearer that the client had, in fact, authorized the transaction.

Third, in a preferred embodiment, the client's Internet address could be obtained from the order packet 204. The merchant either forwards the client's Internet address with the merchant packet 208 or the bank routes the request packet 212 back to the client system 100 through the merchant server 120 which, by definition, to receive the order packet, is in contact with the client system via the Internet 110 and has the client's then-existing Internet address.

The request packet 212 is generated by the bank server 150 and transmitted via the Internet to the client system 100. Recall from above that, although it is noted that the request packet is generated by the bank server, the bank could delegate this function to a third party or back to the merchant. For example, the bank server 150 could simply transmit a participation packet 240 back to the merchant; the merchant server 120 would then generate a request packet 212 to be transmitted to the client system 100. Preferably, even where the request packet 212 were generated by and transmitted to the client system 100 by the merchant server 120, the client system 100 would still forward the authorization packet 216 directly to the bank server 150. Otherwise, if the authorization packet is routed to the bank server through the merchant server, the merchant server would have had access to and opportunity to view all of the information provided by the client system 100 which is necessary to authorize a transaction.

Where the merchant packet 208 has requested approval for an ongoing or repetitive charge, which will occur at least on two dates/times, such information could also preferably be relayed with the request packet 212. Thus, the customer would have an indicator of, not only the dollar amount of the charge, but also whether it will re-occur, and if it does re-occur, the frequency of the recurrence.

The identifying information 504a may include some or all of the client information 308b and or the merchant information 412 from the merchant packet 208. FIG. 5a shows the minimum information to be included in the request packet 212a, to wit purchase information 304c, which would be, at a bare minimum, the dollar value of the requested transaction. It may be preferable, however, to include additional identifying information 504a, shown in FIG. 5b. Identifying information would preferably be information of the type to advise the client of the nature of the transaction being requested. Identifying information 504a preferably includes the merchant who is requesting the transaction, information identifying the account for which the merchant is requesting authorization to charge, and potentially even a brief description of the goods and/or services selected. It is further preferable that the client be advised whether the transaction being requested is for a one time authorization or for a repeating charge (e.g., a monthly subscription to be charged for some period of months).

The authorization packet 216 is generated by the client system 100 and transmitted via the Internet 110 to the bank server 150. The authorization packet could pass through the merchant server 120 or a third party designated by the bank, without being read or stored by it, then be redirected to the bank server 150. The authorization packet 216 includes, at a bare minimum, authorization information 604a. Accounts which are capable of using the present payment system may include, for example, a pin number which a client or customer would enter upon receipt of a request packet, which would subsequently be transmitted to the bank server 150 in the authorization information. The authorization information could be manually entered by the client/customer or it could be obtained directly from the client system 100 as for example, where the information may be drawn automatically from an article 104 installed in an article reader 102 on the client system. Preferably, where the information is automatically mined from the client system 100, a log would be maintained on the client system of purchases approved. Also, a combination of the foregoing methods may be required to provide necessary authorization information 604: to-wit, the client/customer may be requested to manually enter an authorization code as well as the automatic mining of information from, for example, an article 104. To add an additional level of clarity to the customer's request, the customer may be required to certify that he has read and understood the requested transaction and that he specifically approves same by checking a box or the like. Thus, information that the customer has specifically included with the request and consented to same, could be included within the authorization information. It may be necessary to include identifying information 504b with the authorization packet for purposes of allowing the bank server 150 to subsequently coordinate the authorization packet 216 with the merchant packet 208. The identifying information 504b included within the authorization packet could be the same as the identifying information 504a included within the request packet, or some stripped supplemented set of information.

Upon receipt of the authorization packet 216, it is coordinated by the bank server 150 with the merchant packet 208. The coordination could be based on common information contained in both packets; alternatively, the coordination could be based on a mathematical relationship between data in the packets. Common information could be any one or more types or pieces of data contained within the packets, including, but not limited to-account numbers, client name(s), date/time, Internet address(es), the dollar value of the requested transaction, merchant name(s), and the like. The coordination will preferably take place in a relational database such as the active client server 152. A record in the database is created in response to each request packet 212 transmitted. The creation of a record will be automatic if the request packet is generated internally by the bank server 150. However, if a third party or the merchant server 120 generate the request packet, a different procedure may be required. For example, where the bank server does not generate the request packet, but rather sends a participation packet 240 back to the merchant server in response to a merchant packet 208, the record may be created upon transmission of the participation packet back to the merchant. Where a third party receives the merchant packet and, in response, generates the request packet 212, the bank may either delegate all of its duties to the third party (i.e., the third party may then create a record in a database it maintains to later be coordinated by it with an authorization packet 212); or, the third party may transmit a notice to the bank server 150 notifying the bank server of the transmission of a request packet 212 and causing the bank server to create a record related thereto.

Once the packets are successfully coordinated, the transaction is processed in accordance with standard approval process and procedures now utilized in Internet credit card transactions. Approval processed may be performed by either a credit card network 132 or a third party processor 134. Alternatively, the approval may be processed by the customer bank/issuing bank 158.

The approval packet 220 is generated by the bank server 150 and transmitted via the Internet 110 to the merchant server 120. At a minimum, the approval packet includes approval information 704a. The approval packet may also include identifying information 504c, which may be the same as or a stripped or supplemented version of any identifying information 504a and 504b. At any rate, the approval information 704 must be sufficient to either alone or in combination with identifying information 504c-allow the merchant server 120 to coordinate the approval packet 220 with the order packet 204.

The confirmation packet 224 is generated by the merchant server 120 and transmitted via the Internet to the client system 100. The confirmation packet includes at a minimum, confirmation information 804, but also preferably includes identifying information 504d. Identifying information 504d may be a stripped or supplemented version of identifying information 504a through 504c. Preferably, in response to receipt of a confirmation packet 224, the client system 100 would generate a record in a database of purchases maintained on the client system.

### OPERATION

The operation of the two components of the present invention will now be discussed: first, the split transaction model will be discussed; second, the interactive client approval model will be discussed. In a preferred embodiment, both of these elements will be incorporated in a system according to the present invention. However, either one of the components can be implemented separately as well.

### Split Transaction Model

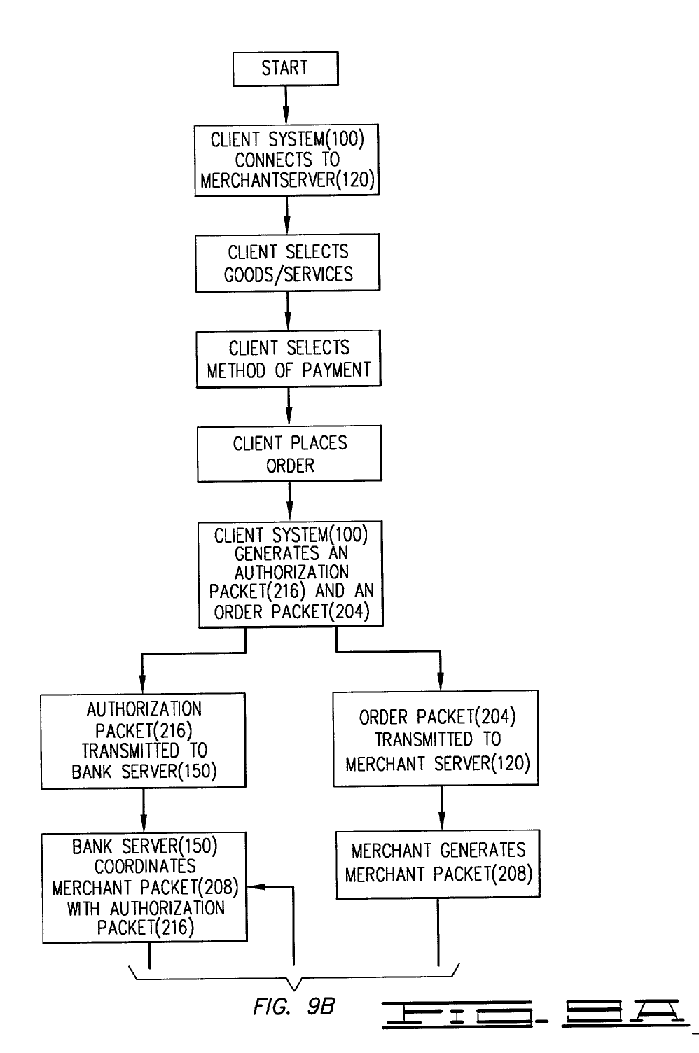

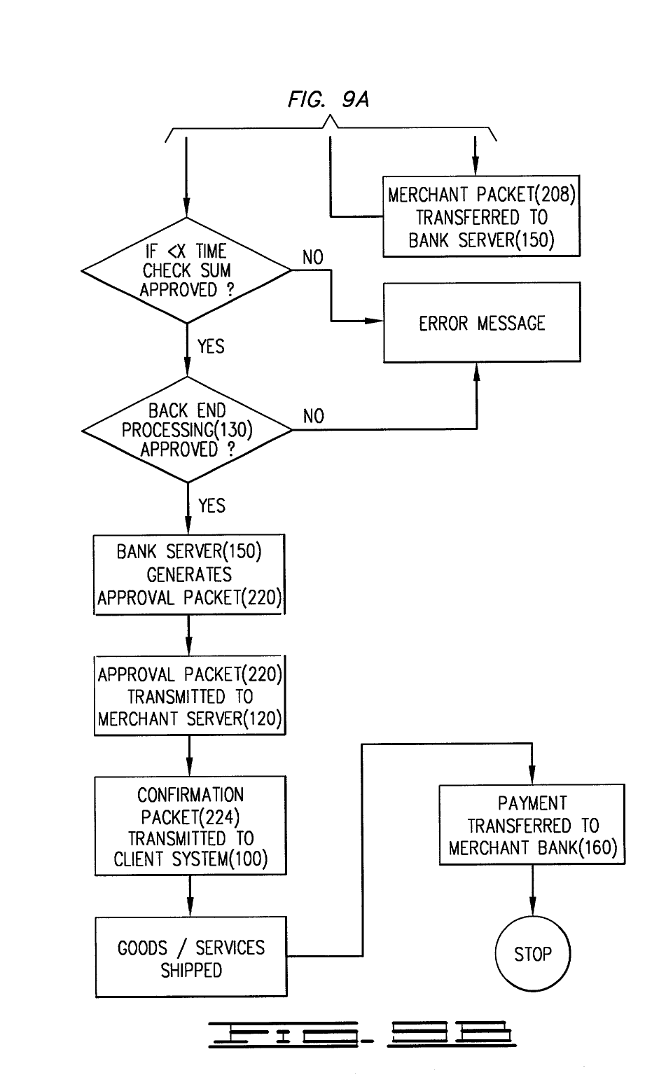

FIG. 9 illustrates the operation of one embodiment of the present invention incorporating the split transaction model. The user first connects to a merchant server 120 via the Internet 110. The client then selects the goods or services to be purchased by browsing the merchant's web site and selecting items, for example by using a shopping cart or a single click-type system. The customer then selects a method of payment. The client's account corresponding to the payment method selected must be issued by an institution employing the present invention to validate online purchases.

The client system 100 then transmits the order, a first part of which—the order packet 204-is sent to the merchant server 120 with a second part—the authorization packet 216—sent to the bank server 150. As noted, the information contained in the order packet 204 is not sufficient by itself to allow the approval of the requested transaction; the data from the order packet 204 as transmitted to the bank server 150 within the merchant packet 208 must be coordinated with the authorization packet 216 to approve a transaction.

Upon receipt of the authorization packet 216, the bank server 150 begins scanning incoming data packets for a merchant packet 208 corresponding to the authorization packet 216. In a relational database, the bank server 150 coordinates the merchant packet 208 and the authorization packet 216.

If the two packets arrive at the bank server 150 within a specified time frame, a checksum is performed to verify that the authorization packet 216 and the merchant packet 208 coordinate properly. If, however, too much time has elapsed between the time the authorization packet 216 arrives at the bank server 150 and the time the merchant packet 208 arrives, an error message is sent to the merchant.

If successful coordination occurs, the bank server 150 passes the request to back end processing 130, and, if approved, generates an approval packet 220. The approval packet 220 is transmitted to the merchant server 120.

The merchant server generates a confirmation packet 224, which is transmitted to the client system 100. The merchant server 120 may also automatically send a command to the merchant business server 122 to deliver the goods or services. The business processes within the merchant's organization to complete this operation. Subsequently, payment is transferred from the issuing bank 158 via the bank network 156 to the merchant bank 160.

Billing for accounts using the present invention may be accomplished by standard mail, as with traditional credit cards. Alternatively, an on line billing system used in conjunction with the Internet only credit card whereby billing statements, instead of being sent by regular mail, are sent by e-mail to the customer. This takes advantage of the fact that e-mail is free, incurring no mailing charges for the credit card issuer. In addition, billing transactions are more rapidly completed as are payment transactions. In fact, using the present invention, there could be transactions that are completely paperless. That is, transactions where no paper is sent from or to any of the parties involved in the transaction. Once a customer receives an e-mail bill, he can merely check a payment method on the e-mail, then press a respond key in the e-mail to forward payment. The e-mail bill may offer the customer a variety of payment methods (e.g., bank draft, or paper check sent under separate cover). At the time the customer's account is established, the customer may choose a preferred method of payment for electronic billing.

### Interactive Client Approval Model

In brick and mortar transactions, a client selects the desired goods; presents his credit card for payment; via a computer network, the amount of the requested transaction is cleared by the bank; and, finally, the customer interactively “authorizes” the transaction by signing the paper receipt. The interactive client approval process is intended to serve as an on-line proxy for the signing of a paper receipt in brick and mortar transactions.

In the Parent Applications, the interactive client approval model was referred to as a “billing method.” As disclosed, the billing method comprised the steps of: (a) upon completion of a transaction or a set of transactions, the bank sending an electronic communication via the Internet to the customer listing the purchases made and the total amount due; (b) a customer selecting a method of payment and responding with the same in an electronic communication via the Internet back to the bank; and (c) the bank completing the payment pursuant to the instructions from the customer in the response of electronic communication. This billing method, which was included as claim 2 in the Parent Application, illustrates the concept of interactive customer approval of online transactions. Consistent with claim 2 of the Parent Application claims are presented herein incorporating that same concept, namely customer approval of requested transactions.

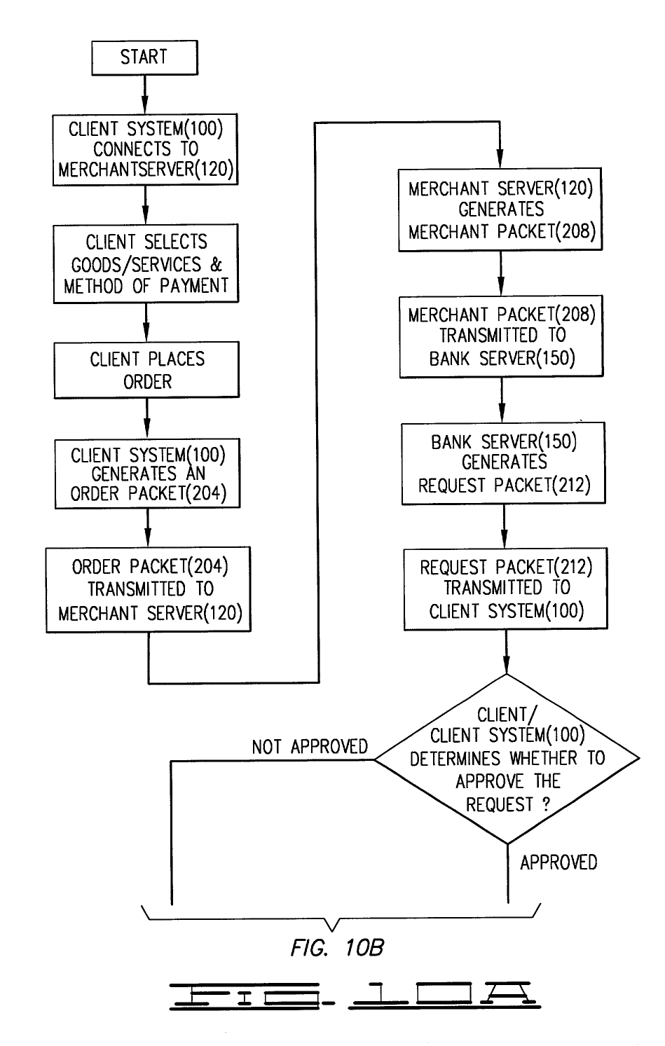

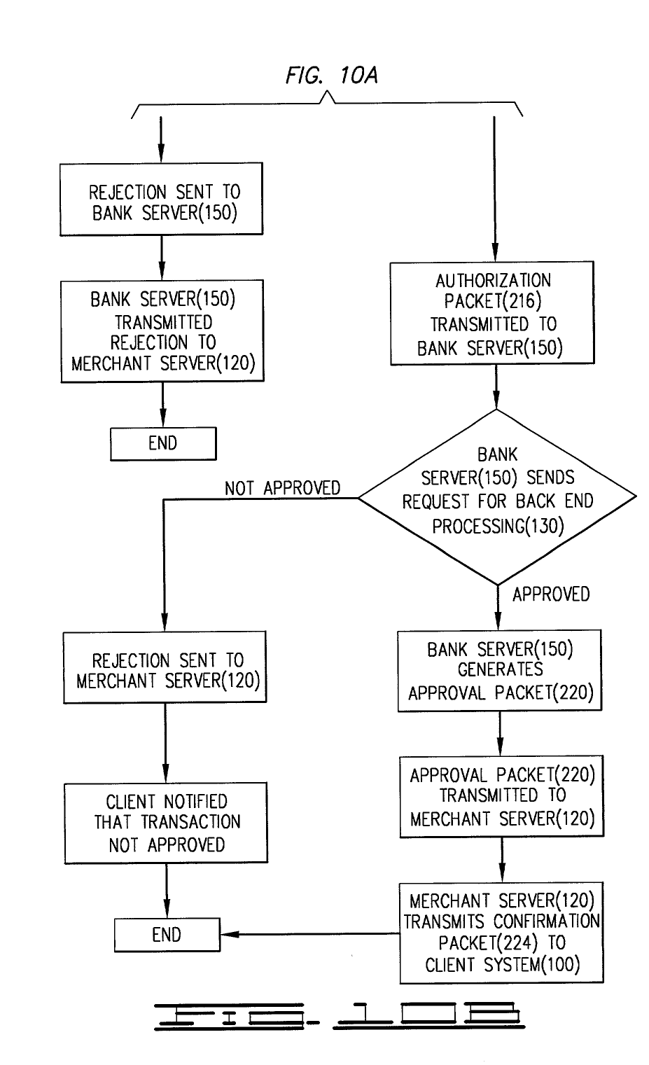

FIG. 10 illustrates the operation of a the present invention incorporating interactive client approval. The client system 100 connects to the merchant server 120 via the Internet 110. The client selects the goods or services from the merchant server 120 and selects the method of payment. The client then places an order, resulting in the client system 100 generating an order packet 204. The order packet 204 is transmitted to the merchant server 120. The merchant server 120 then generates a merchant packet 208 which is transmitted via the Internet 110 to the bank server 150. In response to receipt of the merchant packet 208 the bank server 150 generates a request packet 212, which is transmitted via the Internet to the client system 100.

The client and/or the client system 100 determine whether or not to approve the request packet 212. As noted, the information comprising the authorization packet 216 can either be manually entered by the client or can be mined from the customer system 100. If the data is mined from the customer system 100, it can either be resident on a hard drive or other memory device within the client system 100, or it could be contained on a removable article 104, which can be removably inserted or taken out from the article reader 102. If data to be mined is to be maintained on an article 104, additional security would be provided because once the article 104 is removed from the client system 100, transactions cannot be approved.

If the client/client system approves the request, an authorization packet 216 is transmitted to the bank server 150. Alternatively, if the transaction is not approved, a rejection is sent by the bank server 150 to the merchant server 120. Assuming, however, the transaction is approved by the client/client system 100, an authorization packet 216 is transmitted via the Internet to the bank server 150. Upon receipt of the authorization packet 216, the bank server 150 attempts to coordinate the authorization packet with a corresponding merchant packet. If coordination is successful, the transaction is subjected to standard back end processing 130. Assuming back end processing 130 approves the requested transaction, the bank server 150 generates an approval packet 220, which is transmitted via the Internet to the merchant server 120. Subsequently, the merchant server 120 may generate a confirmation packet 224, which is transmitted via the Internet to the client system 100. After the process has been completed, the merchant server 120 notifies business process 124 to fulfill the order for the goods/services requested. Once the goods/services are shipped or provided, the bank server 150 authorizes the transfer of appropriate funds to the merchant.

Consistent with FIGS. 2 and 10, another embodiment of the present invention operates as follows. Up until the point where the merchant server 120 transmits the merchant packet 208 to the bank server 150, the system operates as described above.

However, instead of the bank server 150 generating and transmitting the request packet 212 through the Internet 110 to the client system 100, the bank server generates a participation packet 240 and transmits it back to the merchant server 120. The participation packet may merely indicate to the merchant server that the payment method specified by the client requires interactive client approval, in which case the merchant server 120 generates the request packet 212 and transmits it to the client system 100. Alternatively, the participation packet 240 may be identical to the request packet 212, in which case the merchant server 120 merely retransmits it to the client system 100 without modification.

Upon receipt of the request packet 212 by the client system 100, this embodiment again preferably operates as described above. However, this embodiment may alternatively require routing the authorization packet 216 back to the bank server 150 through the merchant server 120. It is not clear why routing the authorization packet 216 through the merchant server might be desirable for two reasons: (1) at that point, the merchant might have had access to all of the information required to approve a transaction and could subsequently duplicate the steps for a fraudulent transaction; and (2) the bank server 150 could easily (and likely will) reside at a fixed Internet address which is known to the client system 100 so routing through the merchant server 120 would not be necessary to allow the authorization packet 216 to reach its intended recipient.

### Delegation of Duties by Bank

The operator of the present system, the “bank,” may delegate some or all of its tasks to a third party or even, as noted above, to the merchant. Thus, it must be remembered that when it is said that the bank server 150 performs some action, that action may, in fact, be performed by an entity to which the bank server's duties are delegated. However, it is preferable that not all of the duties be delegated to the merchant because, to do so, would defeat one of the purposes of the present invention, namely preventing the merchant from having access to all of the information needed to approve an on-line transaction. Thus, neither the merchant nor a hacker stealing information from the merchant server 120 could use such information complete fraudulent transactions.

Having thus disclosed the present invention, I claim:

1. An Internet purchasing method comprising the steps of:
a. a customer accessing a merchant server and selecting desired goods and services and placing an order for same, the order resulting in the transmission of an order packet to the merchant server and an authorization packet to a bank server;
b. upon receipt of the order packet, the merchant server generating a merchant packet and transmitting same so that it is received by the bank server;
c. the bank server coordinating the merchant packet with the authorization packet;
d. upon successful coordination, the transaction being subjected to normal back-end processing.

2. The method of step 1 further incorporating the following billing method:
a. upon completion of a transaction or a set of transactions, the bank sending an electronic communication via the Internet to the customer listing the purchase made and the total amount due;
b. the customer selecting a method of payment and responding with the same in an electronic communication via the Internet bank to the bank; and
c. the bank completing the payment pursuant to instructions from the customer in the response electronic communication.

3. A method for performing secure Internet transactions of the type where a customer transmits an order packet to a merchant indicating a desire to engage in a transaction, and the merchant consequently transmits a merchant packet related to the requested transaction, the method comprising:
a. in an interactive mode, obtaining authorization from the customer for the requested transaction, resulting in an authorization packet if approved;
b. coordinating the authorization packet with the merchant packet; and
c. transmitting the requested transaction for back-end processing if coordination is successful.

4. The method of claim 3, where a customer's Internet address for use in the interactive approval process of step (a) is maintained in an active client server after the customer transmits a packet including his Internet address at the time he logs on to the Internet.

5. The method of claim 3, where a customer's Internet address for use in the interactive approval process of step (a) is transmitted to an active client server near the same time as the order packet is transmitted to the merchant.

6. The method of claim 3, where a customer's Internet address for use in the interactive approval process of step (a) is obtained from the order packet.

7. The method of claim 3, where step a is comprised of the following steps:
a. sending a request packet containing information identifying the transaction to the customer;
b. the customer generating an authorization packet if the customer desires to approve the transaction; and
c. transmitting the authorization packet to an administrator of the system.

8. The method of claim 7 where the request packet is routed to the customer through the merchant server.

9. The method of claim 7 where the request packet is generated by the administrator.

10. The method of claim 7 where the request packet is generated by the merchant.

11. The method of claim 7, where a removable article, if present, automatically provides information needed to generate an authorization packet without intervention from the customer, and the purchase cannot be approved unless the article is present.

12. The method of claim 11, where information must also be obtained from the customer manually inputting information.

13. The method of claim 7, where the information needed for the authorization packet is provided by manual input solely from the customer.

14. The method of claim 7, where in step a, a browser displays information related to the nature of the requested transaction.

15. The method of claim 7 where, before step a, a participation packet is sent from an administrator of the present system to the merchant, who generates a request packet and transmits it to the customer.
